(19) United States
(12) Patent Application Publication
(10) Pub. No.: US 2002/0106928 A1
(43) Pub. Date: Aug. 8, 2002

(54) CONDUCTIVE CONNECTING STRUCTURE OF A PIPE-TYPE LAMP

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/776,832

(22) Filed: Feb. 6, 2001

(51) Int. Cl. H01R 13/627

(52) U.S. Cl. 439/362

(57) ABSTRACT

The present invention relates to a conductive connecting structure of a pipe-type lamp, which mainly includes a receiver provided at the end of the electrical wire in the pipe-type lamp for conductive connecting with the pin easily. It also provides a clip to engage with the conductive wire of the bulb firmly and conveniently and it is possible to control each bulb being positioned at a same interval for a perfect lighting decorative effect.

### BACKGROUND OF THE INVENTION

A conventional pipe-type lamp includes a transparent pipe having electrical wire connecting with several bulbs therein. Normally, it uses the conducting pin to insert into the end of the electrical wire in the pipe-type lamp and the pin contacts with the metal wires of electrical wire directly. It can be found that this prior method would break the inner metal wire of the electrical wire, which is been folded. The conductive effect is not good. Furthermore, the connection between the bulbs in the pipe-type lamp is welded, that seems too inconvenient and easily broken when manufacturing. The distance between each two bulbs is not easily controlled and it may affect the decorative effect. Accordingly, the primary object of the invention is to provide an improved conductive connecting structure of a pipe-type lamp, which has provided with a receiver at the end of the electrical wire and the clip to connect with the bulbs together firmly in ease. Now the features and advantages of the present invention will be described in detail with reference to the accompanying drawings.

### BRIEF DESCRIPTION OF ACCOMPANYING DRAWINGS

FIG. 1 is a cross-sectional plan view showing a pipe-type lamp according to the present invention.

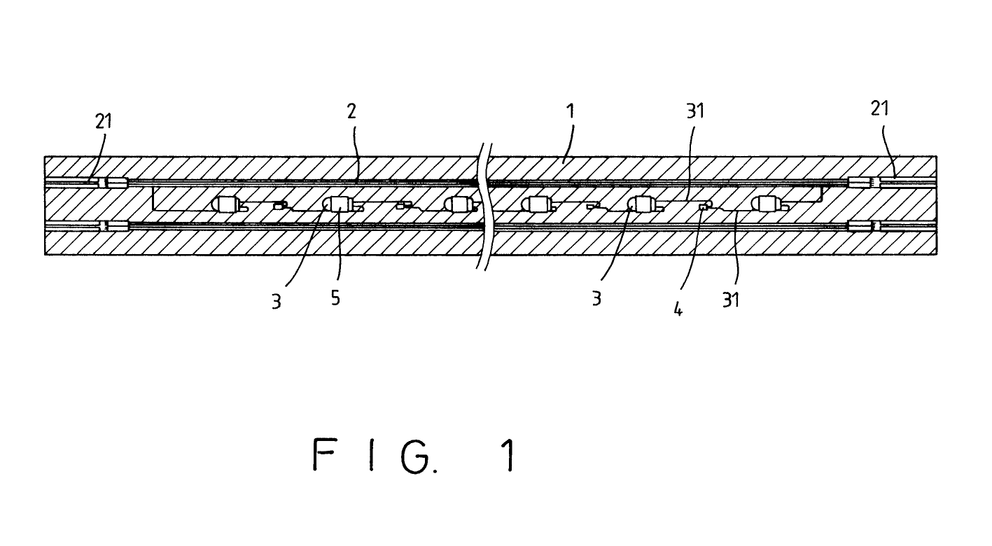

FIG. 2 is a perspective view showing the electrical wire with several bulbs according to the present invention.

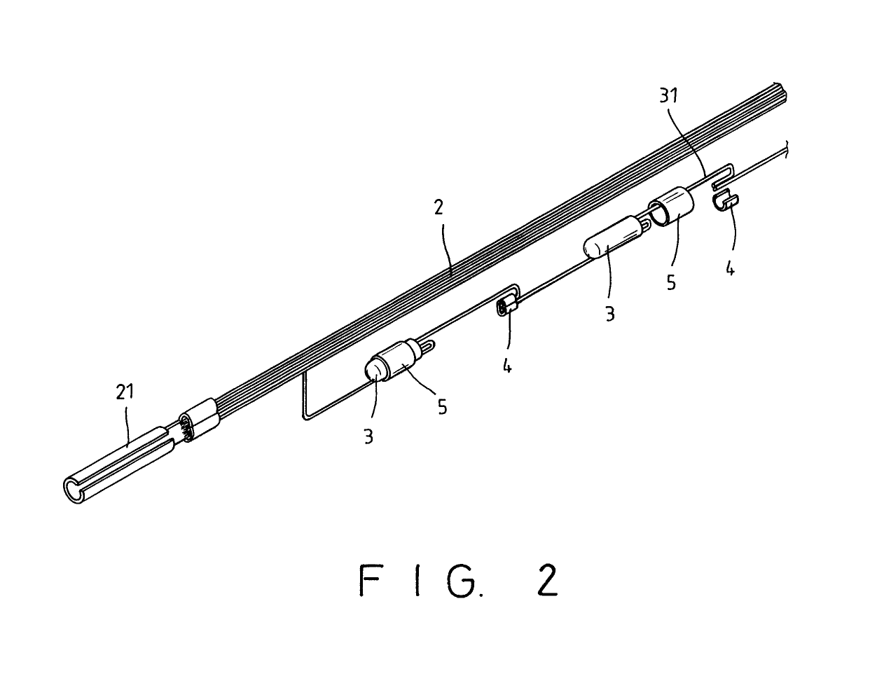

### DETAILED DESCRIPTION OF PREFERRED EMBODIMENTS

Referring to the drawings, the present invention is to provide an improved pipe-type lamp (1) having inner electrical wires (2) and several bulbs (3) in a desired interval. The improvement of this invention is to provide with a receiver (21) connecting with the end metal parts of the electrical wire (2). So it will be very easy to insert the conducting pin into the receiver (21) to obtain a secure conductive connection between the pin and the electrical wire (21). A clip (4) is provided to engage with two conductive wire (31) of every two neighboring bulb (3). By use of the clip (31), the procedure of manufacturing will be more convenient and the interval between the bulbs (3) will be easily controlled for obtaining a promise of quality in lighting decorative effect.

Moreover, It is possible that a transparent ring (5) is provided around the bulb (3) to position the conductive wire (51) along with the bulb (5) for easily manufacturing.

Accordingly, the improved structure of the present invention obtains the effect to manufacture the pipe-type lamp easily. Thus it has excellent practical value in the field. Evidently the invention has the essence of a patent. We hereby apply for a patent grant.

What is claimed is:

1. A conductive connecting structure of a pipe-type lamp including a pipe-type lamp having inner electrical wire with several connecting bulbs in interval; and the characteristic is that a receiver being provided at the end of the electrical connecting with the metal wire of the electrical wire and the outer end of the receiver being capable of conductive connecting with the pin.

2. The conductive connecting structure of a pipe-type lamp as claimed in claim 1, wherein a clip is provided for engaging with two conductive wires of two neighboring bulbs for electrical connection.

3. The conductive connecting structure of a pipe-type lamp as claimed in claim 1, wherein a transparent ring is provided around the bulb to position the conductive wire beside the bulb.
